(19) United States
(12) Patent Application Publication
(10) Pub. No.: US 2015/0134170 A1
(43) Pub. Date: May 14, 2015

(54) DEVICE AND METHOD FOR SETTING PASSWORD

(71) Applicant: SAMSUNG SDI CO., LTD., Yongin-si (KR)

(72) Inventor: Jae-Woo KAM, Yongin-si (KR)

(21) Appl. No.: 14/509,176

(22) Filed: Oct. 8, 2014

(30) Foreign Application Priority Data
Nov. 12, 2013 (KR) 10-2013-0137173

(51) Int. Cl. B60Q 1/00; G07C 9/00; B60L 11/18

(52) U.S. Cl. CPC B60Q 1/00; B60L 11/1861; G07C 9/00126
USPC 701/22

(57) ABSTRACT

A password setting device includes a selection button and a plurality of light-emitting elements. The selection button determines a state of charge of a battery pack and is also used to enter various types of information including symbols of a password. The light-emitting elements to emit light depending on the state of charge of the battery pack in a first mode. At least some of the light-emitting elements correspond to symbols of a password in at least a second mode. The password is to be set or input based on the light-emitting elements that emit light at a time when the selection button is activated in at least the second mode.

### CROSS-REFERENCE TO RELATED APPLICATION

Korean Patent Application No. 10-2013-0137173, filed on Nov. 12, 2013, and entitled, “DEVICE AND METHOD FOR SETTING PASSWORD,” is incorporated by reference herein in its entirety.

### BACKGROUND

1. Field

One or more embodiments herein relate secure access of an electronic system.

2. Description of the Related Art

A variety of user authentication devices have been developed for automatic teller machines, digital door locks, portable terminals, and other electronic systems. These devices often include a keypad for receiving numbers or characters and/or a display unit for displaying various kinds of information.

In operation, a user enters a password by pressing numbers or characters of the keypad or a touch screen. The identity of the user may be authenticated by comparing the entered password with a preset password. Access is given upon authentication.

Vehicles, however, are not protected in this manner. For example, physical locks have been used in an attempt to protect electric bikes and other vehicles. These locks are easily compromised and therefore do not provide an adequate protection.

In terms of performance, the maximum driving distance of an electric vehicle is determined based on a charge state of a battery pack used to drive the motor. In order to notify a user of the charge state of the battery, battery packs have been developed to include a button. When the button is pushed, a display unit outputs a fixed range of colors corresponding to a detected voltage of the battery pack, or a predetermined number of light-emitting elements are illuminated.

### SUMMARY

In accordance with one embodiment, a password setting device includes a selection button to determine a state of charge of a battery pack; and a plurality of light-emitting elements to emit light depending on the state of charge of the battery pack in a first mode, wherein the light-emitting elements respectively correspond to symbols of a password in at least a second mode, and wherein the password is to be set or input based on a combination of the light-emitting elements that emit light at a time when the selection button is activated in at least the second mode.

The device may include a driving controller to enter into one of a plurality of modes based on a manipulation time of the selection button, the plurality of modes including: the first mode including a state of charge display mode to display the state of charge of the battery pack, the second mode including a password setting mode to set the password, a third mode including a password input mode to input the password, and a fourth mode including a lock mode to set the motor in a locked state.

The driving controller may detect the state of charge of the battery pack, and enable at least one of the light-emitting elements to emit light depending on the detected state of charge in the first mode.

The driving controller may sequentially enable the light-emitting elements to emit light in the password setting mode, and set symbols corresponding to the password for each of the light-emitting elements that emit light.

The driving controller may enable the light-emitting elements to sequentially emit light in the password input mode, recognize symbols for the light-emitting elements that emit light, compare the recognized symbols with preset symbols, and selectively unlock a locked state of a host device of the battery pack. The symbols of the password may be one or more of numbers, letters, or characters.

In accordance with another embodiment, a method for setting a password includes enabling a plurality of light-emitting elements to sequentially emit light; and setting or inputting symbols of a password corresponding to the light-emitting elements when a selection button is manipulated, wherein the password controls access to a host device powered by a battery pack. The setting or inputting symbols of the password may include respectively matching the light-emitting elements to different symbols; and storing the set or input symbols matched to the light-emitting elements which emit light based on activation of the selection button.

The method may include entering into one of a plurality of modes based on a manipulation time of the selection button, wherein the plurality of modes includes: a state of charge display mode to display a charge state of the battery pack, a password setting mode to set the password, a password input mode to input the password, and a lock mode to set the host device in a locked state.

Entering into the state of charge display mode may include detecting the state of charge of the battery pack, and enabling at least one of the light-emitting elements to emit light depending on the detected state of charge.

Entering into the password input mode may include comparing a preset password with the set or input password; and unlocking the locked state of the motor when the set or input password matches the preset password. The symbols of the password are one or more of numbers, letters, or characters.

In accordance with another embodiment, an apparatus includes an input to receive signals from a control panel; and a controller to receive a password corresponding to the signals received from the control panel and to compare the received password to a preset password, wherein the controller is to lock a motor of an electric vehicle when the received password does not match the preset password.

The password may include a number of symbols and the controller may identify the symbols based on the light emitters that emit light. The controller may identify the symbols based on a position of the light emitters and logical values of signals received from the light emitters. The light emitters that do not emit light may have a same logical value and correspond to symbols that are not included in the password. The symbols may include one or more of numbers, letters, or characters.

The input may be included in the controller. The controller may generate signals for activating a combination of the light emitters based on a state of charge of a battery pack of the electric vehicle. The controller may control a mode of the control panel based on a selection signal received from the control panel.

### BRIEF DESCRIPTION OF THE DRAWINGS

Features will become apparent to those of skill in the art by describing in detail exemplary embodiments with reference to the attached drawings in which:

FIG. 1 illustrates an embodiment of a system for setting a password; and

FIG. 2 illustrates an embodiment of an operation unit.

### DETAILED DESCRIPTION

Example embodiments are described more fully hereinafter with reference to the accompanying drawings; however, they may be embodied in different forms and should not be construed as limited to the embodiments set forth herein. Rather, these embodiments are provided so that this disclosure will be thorough and complete, and will fully convey exemplary implementations to those skilled in the art.

In the drawing figures, the dimensions of layers and regions may be exaggerated for clarity of illustration. It will also be understood that when a layer or element is referred to as being “on” another layer or substrate, it can be directly on the other layer or substrate, or intervening layers may also be present. Further, it will be understood that when a layer is referred to as being “under” another layer, it can be directly under, and one or more intervening layers may also be present. In addition, it will also be understood that when a layer is referred to as being “between” two layers, it can be the only layer between the two layers, or one or more intervening layers may also be present. Like reference numerals refer to like elements throughout.

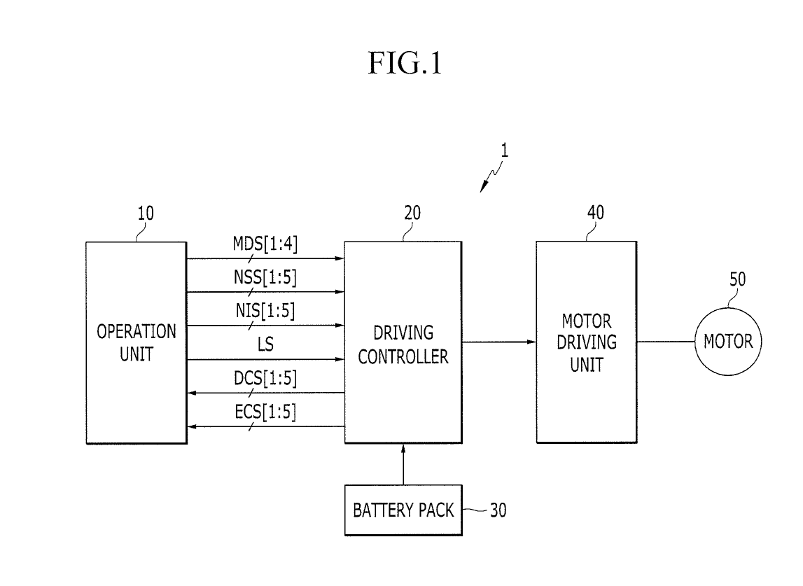

FIG. 1 illustrates an embodiment of a password setting system 1, which, for example, may be applied to an electric vehicle such as but not limited to an electric bike. Referring to FIG. 1, password setting system I includes an operation unit 10, a driving controller 20, a battery pack 30, a motor driving unit 40, and a motor 50.

The operation unit 10 generates first to fourth mode selection signals MDS[1:4] for transmission to driving controller 20. The mode selection signals MDS[1:4] correspond to a plurality of modes, respectively. In one embodiment, the modes include a state of charge display mode for displaying a state of charge of the battery pack 30, a password setting mode for setting the password, a password input mode for inputting the password, and a lock mode for locking operation of motor driver 40.

In the state of charge display mode, operation unit 10 receives first to fifth display signals DCS[1:5] from driving controller 20. The first to fifth display signals DCS [1:5] correspond to the state of charge of battery pack 30, and light is emitted according to the first to fifth display signals DCS[1:5].

In the password setting mode, the operation unit 10 generates first to fifth set signals NSS[1:5] corresponding to a password.

In the password input mode, the operation unit 10 generates first to fifth input signals NIS[1:5] corresponding to a password.

In the lock mode, the operation unit 10 generates a lock set signal LS.

The operation unit 10 transfers the first to fifth set signals NSS[1:5], the first to fifth input signals NIS[1:5], and the first to fifth lock set signals LS to the driving controller 20.

The driving controller 20 detects a state of charge SOC of the battery pack according to the first mode selection signal MDS[1], and generates the first to fifth display signals corresponding to the detected state of charge.

The driving controller 20 may divide the state of charge into a predetermined number of subsets with fixed ranges. For example, the driving controller 20 may divide the state of charge into five subsets within the range of 0% to 100%. The driving controller then determines the subsets to which a detected state of charge of the battery pack of the electric bike belongs.

The driving controller 20 may activate and output one or more display signals corresponding to the subsets among the first to fifth display signals DCS[1:5]. For example, first display signal DCS[1] may be activated when the detected state of charge corresponds to a first subset. The first and second display signal DCS[1:2] may be activated when the detected state of charge corresponds to a second subset, and so on.

The driving controller 20 recognizes a password based on the second mode selection signal MDS[2] and the first to fifth set signals NSS[1:5], and then stores the recognized password.

The driving controller 20 recognizes a password based on the third mode selection signal MDS[3] and the first to fifth input signals NIS[1:5], and then selectively unlocks the lock of the motor driving unit 40 based on a comparison the preset password and the recognized password. The driving controller 20 unlocks the lock of the motor driving unit 40 if the preset password matches the recognized password. If there is not a match, the driving controller maintains the locked state of the motor driving unit 40.

More specifically, the driving controller 20 allows the electric vehicle to be driven when the preset password matches the inputted password, and prohibits the electric bike from being driven when there is no match. Providing this level of security prevents the electric vehicle from being stolen by unauthorized users.

The driving controller 20 generates first to fifth light emitting signals that may be sequentially activated according to the second and third mode selection signal MDS[2:3], and transfers them to operation unit 10. For example, the driving controller 20 may activate the first to fifth light emitting signals ECS[1:5] every predetermined time interval, e.g., every second.

The driving controller 20 converts an operational state of the motor driving unit 40 into a locked state according to the fourth mode selection signal MDS[4]. In one embodiment, a locked state corresponds to a state in which the driving of motor 50 is prohibited.

The battery pack 30 supplies a predetermined level of driving power to the motor 50. The battery pack 30 may include one or more battery cells capable of being charged and discharged. The battery cells may be any one of a variety of cells, including but not limited to lithium ion battery cells.

The motor 50 is driven by the motor driving unit 40 for purposes of rotating one or more wheels of the electric vehicle.

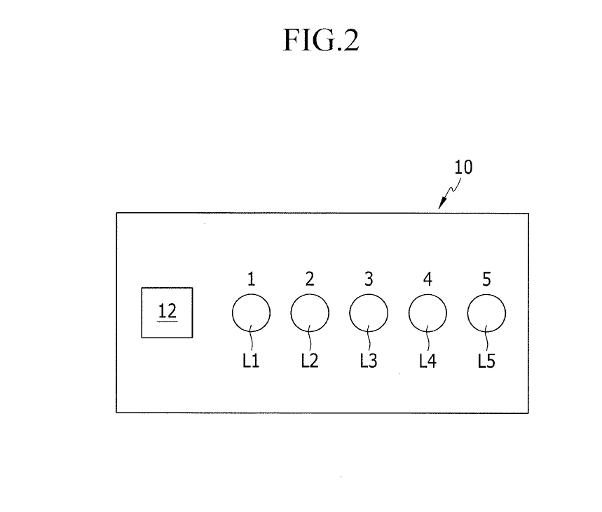

FIG. 2 illustrates an embodiment of operation unit 10 which includes a selection button 12 and first to fifth light emitting elements L1 to L5. The selection button 12 may be a mode selection button for selecting one of the state of charge display mode, password setting mode, password input mode, or lock mode.

In one embodiment, selection button 12 generates the first to fourth mode selection signals when a mode is selected based on a button manipulation time. For example, the password setting mode is entered when selection button 12 is continuously pressed for about 10 seconds. The state of charge display mode is entered when the selection button 12 is continuously pressed for about 20 seconds. Other modes may be selected based on other button manipulation times.

The selection button 12 may also function as a number input button, for selecting a number which corresponds to one of the first to fifth light emitting elements L1 to L5. The first to fifth light emitting elements may separately emit light in sequence.

For example, when used as a number input button, selection button 12 generates the first to fifth set signals NSS[1:5] and/or the first to fifth input signals NIS[1:5] at a signal level corresponding to a logic signal 1 or 0 based on which one of light emitting elements L1 to L5 are selected. In one embodiment, in the password setting mode, the first set signal NSS[1] is generated at a signal level corresponding to the logic signal 1 when the selection button 12 is pressed when the first light emitting element L1 emits light. The first set signal NSS[1] is generated at a signal level corresponding to the logic signal 0 when the selection button 12 is not pressed, or when another light emitting element emits light.

The first to fifth light-emitting elements L1 to L5 selectively emit light in response to the first to fifth display signals DCS[1:5], respectively. Moreover, the first to fifth light-emitting elements L1 to L5 selectively emit light in response to the first to fifth light emitting signals ECS[1:5], respectively. In one embodiment, the first to fifth light-emitting elements L1 to L5 may be light emitting diodes (LED).

The first to fifth light-emitting elements L1 to L5 respectively correspond to input keys of a password. The first to fifth light-emitting elements L1 to L5 respectively match the respective different input keys. The input key matched to each of the first to fifth light emitting elements may be stored in advance, for example, in the driving controller 20. In one embodiment, each of the first to fifth light-emitting elements L1 to L5 may correspond to a number, a letter, or other character.

The aforementioned embodiment has described a case in which the operation unit 10 has five light-emitting elements. In other embodiments, n light-emitting elements may be used, where n is different from 5. In this case, 2n passwords may be set and inputted by using n light-emitting elements.

The number of light-emitting elements among the first to fifth light-emitting elements L1 to L5 may be activated based on the subset in which the state of charge of the battery pack 30 lies. For example, when the state of charge of the battery pack is partitioned into five possible subsets, the first light-emitting element L1 may emit light when the battery charge is detected to lie within the first (e.g., a lowest voltage range) subset. The first and second light-emitting elements L1 and L2 may emit light in a second (e.g., a succeeding voltage range) subset, and so on.

Operation of the operation unit 10 will now be described in the illustrative case of where first to fifth light-emitting elements L1 to L5 respectively correspond to digits 1, 2, 3, 4, and 5. Initially, selection button 12 is used to enter the password input mode. In this case, the selection button 12 may be continuously pressed for about 10 seconds, and the second mode selection signal MDS [2] is activated.

Then, the driving controller 20 outputs the first to fifth light-emitting signals

ECS[1:5] every second by activating them in sequence. Accordingly, the first to fifth light-emitting elements L1 to L5 are sequentially turned on every second.

Next, when the first light-emitting element L1 emits lights, the first set signal NSS[1] is generated at a level corresponding to logic signal 1 when the selection button 12 is pressed. The first set signal NSS[1] is generated at a level corresponding to logic signal 0 when the selection button 12 is not pressed. For example, when selecting button 12 is pressed when the first, third, and fourth light-emitting elements emit light, the first to fifth set signals NSS[1:5] correspond to a logic signal “10110.”

Then, the driving controller 20 sets and stores the password as “134.” That is, each of the first to fifth light-emitting elements is used as a numeric key. In this case, the password is set and input by selecting corresponding numbers through use of the selection button 12, when the light-emitting elements corresponding to desired numbers emit light.

When selection button 12 is continuously pressed for about 10 seconds, the state of charge display mode is entered and the second mode selection signal MDS[1] is activated.

Next, the driving controller 20 detects the state of charge of the battery pack 30, and determines the subset corresponding to the detected state of charge. For example, when the state of charge of the battery pack 30 corresponds to the third subset, the driving controller 20 activates and outputs the first to third display signals DCS[1:3] among the first to fifth display signals DCS[1:5]. Then, the first to third light-emitting elements L1, L2, and L3 emit light to indicate to a user that the state of charge corresponds to the third subset.

That is, in this embodiment, the password may be set and input using the single selection button 12 for displaying the state of charge of the battery pack 30 and the first to fifth light-emitting elements L1 to L5. Accordingly, a keypad or display area is not required, thereby reducing costs.

In other embodiments, the foregoing device and method may be applied to other type of vehicles or electronic systems. For example, the devices and methods described herein may be applied to any device powered by a battery pack and which includes a motor. Examples include a power drill, in which a button and display unit for displaying a state of charge are provided to set a password.

Example embodiments have been disclosed herein, and although specific terms are employed, they are used and are to be interpreted in a generic and descriptive sense only and not for purpose of limitation. In some instances, as would be apparent to one of skill in the art as of the filing of the present application, features, characteristics, and/or elements described in connection with a particular embodiment may be used singly or in combination with features, characteristics, and/or elements described in connection with other embodiments unless otherwise indicated. Accordingly, it will be understood by those of skill in the art that various changes in form and details may be made without departing from the spirit and scope of the present invention as set forth in the following claims.

What is claimed is:

1. A password setting device, comprising:
a selection button to determine a state of charge of a battery pack; and
a plurality of light-emitting elements to emit light depending on the state of charge of the battery pack in a first mode, wherein at least some of the light-emitting elements correspond to symbols of a password in at least a second mode, and wherein the password is to be set or input based on the light-emitting elements that emit light at a time when the selection button is activated in at least the second mode.

2. The device as claimed in claim 1, further comprising
a driving controller to enter into one of a plurality of modes based on a manipulation time of the selection button, the plurality of modes including:
the first mode including a state of charge display mode to display the state of charge of the battery pack,
the second mode including a password setting mode to set the password,
a third mode including a password input mode to input the password, and
a fourth mode including a lock mode to set a motor in a locked state.

3. The device as claimed in claim 2, wherein the driving controller is to:
detect the state of charge of the battery pack, and
enable at least one of the light-emitting elements to emit light depending on the detected state of charge in the first mode.

4. The device as claimed in claim 2, wherein the driving controller is to:
sequentially enable the light-emitting elements to emit light in the password setting mode, and
set symbols of the password corresponding to the light-emitting elements that emit light.

5. The device as claimed in claim 4, wherein the driving controller is to:
enable the light-emitting elements to sequentially emit light in the password input mode,
recognize symbols for the light-emitting elements that emit light,
compare the recognized symbols with preset symbols, and
selectively unlock a locked state of a host device of the battery pack.

6. The device as claimed in claim 1, wherein the symbols of the password are one or more of numbers, letters, or characters.

7. A method for setting a password, the method comprising:
enabling a plurality of light-emitting elements to emit light; and
setting or inputting symbols of a password corresponding to the light-emitting elements when a selection button is manipulated, wherein the password controls access to a host device powered by a battery pack.

8. The method as claimed in claim 7, wherein setting or inputting symbols of the password includes:
respectively matching the light-emitting elements to different symbols; and
storing the set or input symbols matched to the light-emitting elements which emit light based on activation of the selection button.

9. The method as claimed in claim 7, further comprising:
entering into one of a plurality of modes based on a manipulation time of the selection button, wherein the plurality of modes includes:
a state of charge display mode to display a charge state of the battery pack,
a password setting mode to set the password,
a password input mode to input the password, and
a lock mode to set the host device in a locked state.

10. The method as claimed in claim 9, wherein entering into the state of charge display mode includes:
detecting the state of charge of the battery pack, and
enabling at least one of the light-emitting elements to emit light depending on the detected state of charge.

11. The method as claimed in claim 9, wherein entering into the password input mode includes:
comparing a preset password with the set or input password; and
unlocking the locked state of a motor when the set or input password matches the preset password.

12. The method as claimed in claim 7, wherein the symbols of the password are one or more of numbers, letters, or characters.

13. An apparatus, comprising:
an input to receive signals from a control panel; and
a controller to receive a password corresponding to the signals received from the control panel and to compare the received password to a preset password, wherein the controller is to lock a motor when the received password does not match the preset password.

14. The apparatus as claimed in claim 13, wherein:
the password includes a number of symbols; and
the controller is to identify the symbols based on light emitting elements that emit light.

15. The apparatus as claimed in claim 14, wherein the controller is to identify the symbols based on a position of the light emitting elements and logical values of signals received from the light emitters.

16. The apparatus as claimed in claim 15, wherein light emitting elements that do not emit light have a same logical value and correspond to symbols that are not included in the password.

17. The apparatus as claimed in claim 16, wherein the symbols include one or more of numbers, letters, or characters.

18. The apparatus as claimed in claim 13, wherein the input is included in the controller.

19. The apparatus as claimed in claim 13, wherein the controller is to generate signals for activating a combination of the light emitting elements based on a state of charge of a battery pack of the electric vehicle.

20. The apparatus as claimed in claim 13, wherein the controller controls a mode of the control panel based on a selection signal received from the control panel.
